(19) United States
(12) Patent Application Publication
(10) Pub. No.: US 2013/0067006 A1
(43) Pub. Date: Mar. 14, 2013

(54) Information Combining Method, Terminal, and IM System

(71) Applicant: Tao Luan, Shenzhen (CN)

(72) Inventor: Tao Luan, Shenzhen (CN)

(21) Appl. No.: 13/643,521

(22) PCT Filed: Jan. 21, 2011
(86) PCT No.: PCT/CN11/70465

§ 371 Date: Nov. 27, 2012

(30) Foreign Application Priority Data
May 5, 2010 (CN) 201010168003

(51) Int. Cl. G06F 17/30; G06F 15/16

(52) U.S. Cl. 709/206; 707/736; 707/E17.009

(57) ABSTRACT

Embodiments of the present invention provide an information combining method, a terminal and an Instant Messaging (IM) system. The method includes: receiving, by a terminal, original tips, and the original tips comprise a tag; parsing, by the terminal, the tag, replacing the tag in the original tips with corresponding terminal information, and generating final tips; displaying, by the terminal, the final tips. The information combining method, terminal and IM system provided by the present invention achieve the tips' generation in terminal, thereby simplifying the process for the server to issue tips to the terminal, and then enhancing the efficiency of the server, saving resources. In addition, it promotes the enrichment of content of the tips, and enhances the user experience.

### FIELD OF THE INVENTION

The present invention relates to communication technology field, and more particularly, to an information combining method, terminal and Instant Messaging (IM) system.

### BACKGROUND OF THE INVENTION

Developing to nowadays, IM technology has been accepted by the majority of users. It is widely used not only in usual recreation, but also in daily work, and has become an essential software tool of the users. Therefore, the users have a high demand for ease of use, stability, security, and the like, of IM software.

In the operational phase of the IM software, in order to achieve a more flexible operational purpose, bring better experience to the users, a server inevitably needs to dynamically issue some prompt information, such as tips, to a terminal. In many cases, Tips issued to the terminal by the server need to include some information stored in the terminal (namely, terminal information). At present, the process for the server to issue the tips includes the following. The server obtains terminal information stored in the terminal from the terminal via a network protocol, then generates tips according to the terminal information, and issues the tips to the terminal.

In the process of achieving the present invention, the inventor finds that above process have the following obvious defects.

In the aspect of network bandwidth, the protocol interaction during the server obtaining terminal information in the exiting process consumes network bandwidth. As to server implementation, it is necessary for the server to consume resources to achieve various logics for obtaining terminal information and generating tips, thus it is complex to be implemented and has a large cost.

### SUMMARY OF THE INVENTION

Embodiments of the present invention provide a information combining method, a terminal and an IM system, which can simplify the process for a server to issue tips to a terminal, thus enhance the efficiency of the server, save resources, and promote the enrichment of content of tips, improve user experience.

The information combining method provided by embodiments of the present invention includes:

receiving, by a terminal, original tips, and the original tips include a tag;

parsing, by the terminal, the tag, replacing the tag in the original tips with corresponding terminal information, and generating final tips;

displaying, by the terminal, the final tips.

Preferably, wherein receiving, by the terminal, original tips, and the original tips include a tag includes:

receiving, by the terminal, the original tips transmitted by a first server, a portion corresponding to terminal information in the original tips is referred by a tag;

one tag refers to terminal information of one terminal; the terminal information includes various information related to the terminal, a contact and a buddy of the terminal.

Preferably, wherein the tag includes a tag name and a tag parameter, the tag name and the tag parameter jointly determine terminal information to which the tag refers;

the tag name indicates a type of the terminal information to which the tag refers; the tag parameter indicates specific terminal information of the type.

Preferably, wherein parsing, by the terminal, the tag, replacing the tag in the original tips with corresponding terminal information, and generating final tips includes:

parsing, by the terminal, the tag;

searching, by the terminal, terminal information stored in the terminal itself or a second server for terminal information to which the tag refers according to the tag name and the tag parameter of the tag;

replacing, by the terminal, the tag in the original with the terminal information to which the tag refers, and generating final tips.

Preferably, wherein the terminal is a terminal in an Instant Messaging system; the first server is a server in the Instant Messaging system.

Embodiments of the present invention also provide a terminal for implementing above mentioned method, the terminal includes: an information receiving module, a parsing and combining module and an information displaying module; wherein

the information receiving module is to receive original tips, and the original tips includes a tag;

the parsing and combining module is to parse the tag, replace the tag in the original tips with corresponding terminal information, and generate final tips;

the information displaying module is to display the final tips generated by the parsing and combining module.

Preferably, the terminal further includes:

a data storing module, which is to store terminal information, and provide an access interface for other modules of the terminal; the terminal information includes various information related to the terminal itself, a contact and a buddy of the terminal.

Preferably, wherein the tag refers to a portion corresponding to terminal information in the original tips.

Preferably, wherein the tag includes a tag name and a tag parameter; the tag name and the tag parameter jointly determine terminal information to which the tag refers;

the tag name indicates a type of terminal information to which the tag refers; the tag parameter indicates specific terminal information of the type.

Preferably, wherein the parsing and combining module includes:

a parsing unit, to parse the tag;

a searching unit, to search the data storing module or a second server for terminal information to which the tag refers;

a combining unit, to replace the tag in the original tips with the terminal information searched out by the searching unit, and generate the final tips. and combining module.

Correspondingly, embodiments of the present invention further provide an IM system for implementing above mentioned method, the system includes: a first server and a terminal;

the first server is to transmit original tips to the terminal, a portion corresponding to terminal information in the original tips is referred by a tag;

the terminal is to receive the original tips, and parse the tag, replace the tag in the original tips with corresponding terminal information, generate final tips, and display the final tips.

Preferably, the system further includes:

a second server, to store terminal information, and provide an access interface for the terminal;

the terminal parses the tag, obtains corresponding terminal information from terminal information stored in the terminal, or from the second server, and replaces the tag in the original tips with obtained terminal information.

The information combining method, terminal and IM system provided by the present invention achieve the tips' generation in terminal, thereby simplifying the process for the server to issue tips to the terminal, and then enhancing the efficiency of the server, saving resources. In addition, it is conductive to add more terminal information in tips, and as a result the content of tips is richer, the usage is more intimate, and the user experience is enhanced.

### BRIEF DESCRIPTION OF DRAWINGS

Exemplary embodiment of the present invention will be described in detail hereinafter with reference to accompanying drawings, so as to make above mentioned and other technical solutions and advantages of the present invention clearer to one skilled in the art.

FIG. 1 is a flowchart illustrating an information combining method according to a first embodiment of the present invention.

FIG. 2 is a flowchart illustrating an information combining method according to a second embodiment of the present invention.

FIG. 3 is a schematic diagram illustrating an IM system according to an embodiment of the present invention.

FIG. 4 is a schematic diagram illustrating a terminal according to a first embodiment of the present invention.

FIG. 5 is a schematic diagram illustrating a terminal according to a second embodiment of the present invention.

### DETAILED DESCRIPTION OF THE INVENTION

Information combining method, terminal and IM system provided by embodiments of the present invention generate the tips in terminal side.

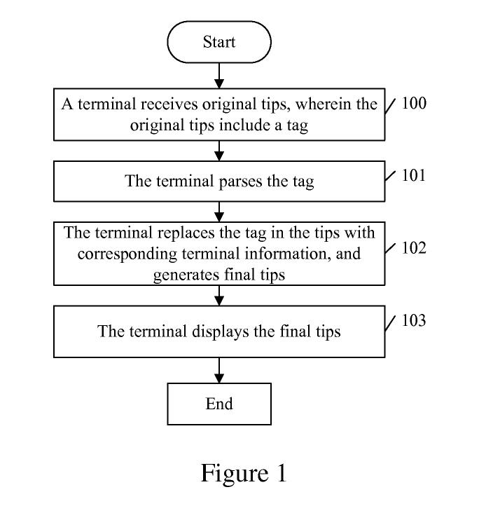

FIG. 1 is a flowchart illustrating an information combining method according to a first embodiment of the present invention. As shown in FIG. 1, the method includes the following processes.

In block 100, a terminal receives original tips, wherein the original tips include a tag.

In block 101, the terminal parses the tag.

In block 102, the terminal replaces the tag in the tips with corresponding terminal information, and generates final tips.

In block 103, the terminal displays the final tips.

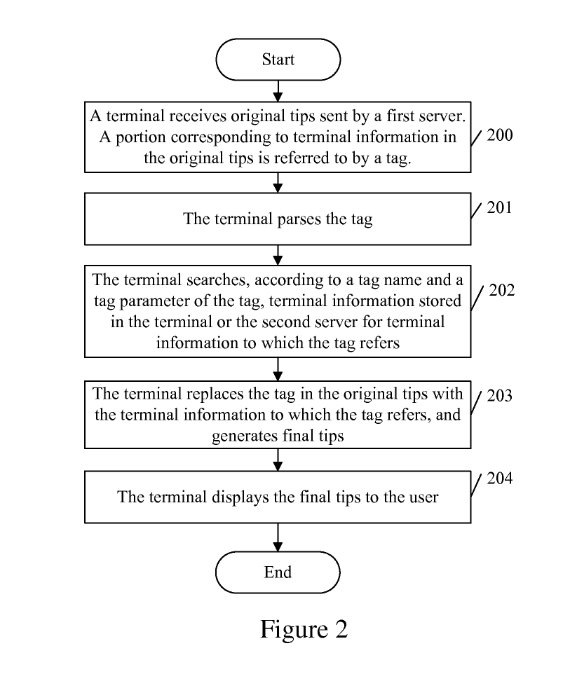

FIG. 2 is a flowchart illustrating an information combining method according to a second embodiment of the present invention. In the present embodiment, the information combining method will be described in more detail. As shown in FIG. 2, the method includes the following processes.

In block 200, a terminal receives original tips sent by a first server. A portion corresponding to terminal information in the original tips is referred to by a tag.

More specifically, the first server may actively transmit the original tips to the terminal, or the first server may transmit the original tips to the terminal after being triggered by an operation of the terminal. For instance, an IM user whose number is 1234567 sends an email to the terminal through the first server. In this case, the first server will actively transmit tips to the terminal to prompt a user of the terminal to receive the email. In the present embodiment, suppose the original tips are “<Terminal name>, <Sender name>sends you an email, please check and confirm”, and the actual terminal name is “ZhangSan”, the actual sender name is “LiSi”.

According to the existing processing manner, the first server needs to obtain terminal information, namely terminal name “ZhangSan” and sender name “LiSi”, required in tips from the terminal first, next combines obtained terminal information and original tips, then generates complete final tips “ZhangSan, LiSi sends you an email, please check and confirm” and transmits the final tips to the terminal.

As can be seen from above, the first server obtains the terminal information from the terminal first, and transmits the terminal information to the terminal later, which is repeated, and wastes network bandwidth and resources of the first server. In order to avoid the above problem, in present embodiment, when transmitting the tips, the first server does not need to obtain the terminal information, just utilize a tag to refer to the portion corresponding to terminal information in the tips. In the present embodiment, the original tips transmitted by the first server to the terminal are “<Tag 1>, <Tag 2> sends you an email, please check and confirm”.

In block 201, the terminal parses the tag.

More specifically, the tag includes at least tow parts, namely, tag name and tag parameter. The tag name and the tag parameter may jointly determine terminal information to which the tag refers. The tag name indicates a type of terminal information to which the tag refers. The tag parameter indicates the specific terminal information of the type. Certainly, when data volume is too big and data classification is finer, one tag parameter may not be sufficient to determine terminal information. In this case, it is possible to introduce multiple parameters to uniquely determine the terminal information to which the tag refers.

In practice, terminal information may be stored in a terminal or a second server. Terminal information stored in the terminal includes various information related to the terminal itself as well as contacts or buddies of the terminal. The second server is adapted to store terminal information of all terminals in the network. Terminal information stored in the second server includes all information related to terminals in the network.

The terminal information stored in the terminal, for example, is shown in table 1.

TABLE 1

| | Type | | | |
|---|---|---|---|---|
| Number | Nickname | Gender | Age | Remark |
| 1234560 | ZhangSan | Male | 31 | — |
| 1234561 | WangWu | Female | 28 | Family |
| 1234562 | HuangEr | Male | 52 | Family |
| 1234563 | ZhaoYi | Female | 30 | Buddy |
| 1234564 | QianLiu | Male | 31 | Buddy |
| 1234565 | SunQi | Male | 45 | Buddy |
| 1234566 | ChengBa | Female | 33 | Colleague |
| 1234567 | LiSi | Male | 35 | Colleague |
| 1234568 | LinJiu | Male | 54 | Colleague |

In the present embodiment, the tag name is the type to which the terminal information belongs, and the tag parameter is a number of the terminal itself or a contact of the terminal, so the tag name and the tag parameter may uniquely determine the terminal information. For instance, in above mentioned example of the present embodiment, <Tag 1> actually refers to “ZhangSan”, so specific content of the <Tag 1> is <Nickname, 1234560>. <Tag 2> actually refers to “LiSi”, so specific content of the <Tag 2> is <Nickname, 1234567>.

Furthermore, the tag in original tips in embodiments of the present invention starts with “<” and ends with “>”. The tag name and parameter name are case-insensitive. The tag does not support nesting. In order to avoid the problem that the terminal can not recognize the tag when original tips contains symbols “<” and “>”, it is possible to define an escape character, for instance, “%” may be defined as an escape character. That is to say, if the body of the original tips contains “<”, “>” or “%”, the symbols “<”, “>” or “%” in the body of the original tips are expressed as “%<”, “%>” or “%%” in original tips transmitted by the first server.

In block 202, the terminal searches, according to a tag name and a tag parameter of the tag, terminal information stored in the terminal or the second server for terminal information to which the tag refers.

More specifically, the <Tag 1> in the embodiment is taken as an example, the terminal may determine a type of terminal information to which the <Tag 1> refers first according to the tag name “Nickname”, and then determine that specific terminal information to which the <Tag 1> refers is “ZhangSan” according to the tag parameter “1234560”. Similarly, the terminal may determine terminal information to which the <Tag 2> refers is “LiSi” according to the tag name and tag parameter of the <Tag 2>.

Above tag format and corresponding terminal information searching manner may be used in the situation that the amount of terminal data is large and storage formats of various types of terminal data are inconsistent, and has wide adaptability and better portability.

Preferably, the terminal in the present embodiment includes: a mobile terminal, a client, a personal computer (PC) terminal. Each type of terminal may be limited by its own hardware, so that it does not store complete terminal information in local, or even stores no terminal information in local. When the terminal stores no terminal information or fails to search out corresponding terminal information from terminal information stored in the terminal, the terminal may obtain corresponding terminal information from the second server.

In block 203, the terminal replaces the tag in the original tips with the terminal information to which the tag refers, and generates final tips.

More specifically, in the embodiment, the terminal has determined that <Tag 1> refers to “ZhangSan”, <Tag 2> refers to “LiSi”, then the terminal replaces <Tag 1> and <Tag 2> in the original tips with determined terminal information, and generates the final tips. That is, the final tips are “ZhangSan, LiSi sends you an email, please check and confirm”.

In block 204, the terminal displays the final tips to the user.

It should be noted that, in the present embodiment, the terminal may be a terminal in an IM system, and the first server may be a server in the IM system.

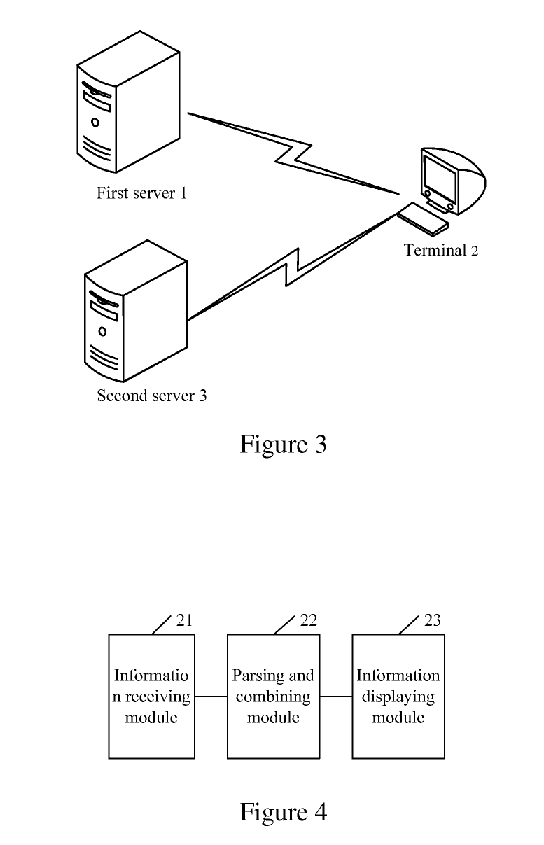

FIG. 3 is a schematic diagram illustrating an IM system according to an embodiment of the present invention. As shown in FIG. 3, the system includes a first server 1 and a terminal 2.

The first server 1 is configured to transmit original tips, and a portion corresponding to terminal information in the original tips is referred by a tag.

The terminal 2 is configured to receive the original tips transmitted by the first server 1, and parse the tag, replace the tag in the original tips with corresponding terminal information, generate final tips, and display the final tips.

Preferably, the system also includes a second server 3 which is configured to store terminal information, and provide an access interface for the terminal 2. The terminal 2 parses the tag, and obtains corresponding terminal information in local or from the second server 3, and replaces the tag in the original tips with the corresponding terminal information.

FIG. 4 is a schematic diagram illustrating a terminal according to a first embodiment of the present invention. As shown in FIG. 4, the terminal includes an information receiving module 21, a parsing and combining module 22 and an information displaying module 23.

The information receiving module 21 is configured to receive original tips, the original tips includes a tag.

The parsing and combining module 22 is configured to parse the tag, replace the tag in the original tips with corresponding terminal information, and generate final tips.

The information displaying module 23 is configured to display the final tips generated by the parsing and combining module 22.

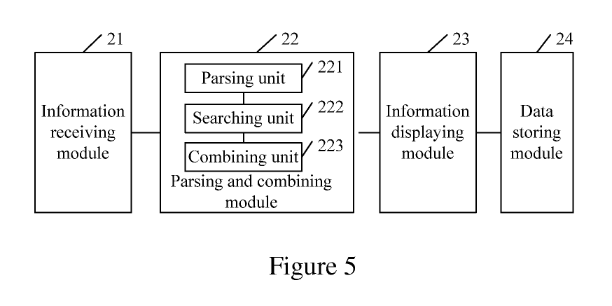

FIG. 5 is a schematic diagram illustrating a terminal according to a second embodiment of the present invention. In the present embodiment, function and structure of the terminal will be described in more detail. As shown in FIG. 5, the terminal also includes an information receiving module 21, a parsing and combining module 22 and an information displaying module 23. The terminal provided by the present embodiment may further includes a data storing module 24 which is configured to store terminal information, and provide an access interface for other modules of the terminal. The terminal information includes various information related to the terminal, a contact and a buddy of the terminal.

In the present embodiment, the information receiving module 21 is configured to receive original tips, the original tips includes a tag.

More specifically, the first server may actively transmit the original tips to the terminal, or the first server may transmit the original tips to the terminal after being triggered by an operation of the terminal. For instance, an IM user whose number is 1234567 sends an email to the terminal through the first server. In this case, the first server will actively transmit tips to the terminal to prompt a user of the terminal to receive the email. Suppose the original tips are “<Terminal name>, <Sender name> sends you an email, please check and confirm”, and the actual terminal name is “ZhangSan”, the actual sender name is “LiSi”.

According to the existing processing manner, the first server needs to obtain terminal information, namely terminal name “ZhangSan” and sender name “LiSi”, required in tips from the terminal first, next combines obtained terminal information and original tips, then generates complete final tips “ZhangSan, LiSi sends you an email, please check and confirm” and transmits the final tips to the terminal. The process for the first server to obtain the terminal information is repeated, and wastes network bandwidth and resources of the first server.

In order to avoid the above problem, in present embodiment, the final tips are generated in the terminal. When transmitting the tips, the first server does not need to obtain the terminal information, just utilize a tag to refer to the portion corresponding to terminal information in the tips. In the present embodiment, the information receiving module 21 receives the original tips transmitted by the first server, and the original tipsare “<Tag 1>, <Tag 2> sends you an email, please check and confirm”.

The parsing and combining module 22 is configured to parse the tag, replace the tag in the original tips with corresponding terminal information, and generate final tips. More specifically, the parsing and combining module 22 may includes a parsing unit 221, a searching unit 222 and a combining unit 223.

The parsing unit 221 is configured to parsing the tag.

More specifically, the tag includes at least tow parts, namely, tag name and tag parameter. The tag name and the tag parameter may jointly determine terminal information to which the tag refers. The tag name indicates a type of terminal information to which the tag refers. The tag parameter indicates the specific terminal information of the type. Certainly, when the amount of data is too large and data classification is finer, one tag parameter may not be sufficient to determine terminal information. In this case, it is possible to introduce multiple parameters to uniquely determine the terminal information to which the tag refers.

In practice, terminal information of all terminals in the network may be stored in a second server. If the terminal includes a data storing module 24, the data storing module 24 usually stores a mass of terminal information, for example, as shown in table 1. In the present embodiment, the tag name is the type to which the terminal information belongs, and the tag parameter is a number of the terminal itself or a contact of the terminal, so the tag name and the tag parameter may uniquely determine the terminal information. For instance, in above mentioned example of the present embodiment, <Tag 1> actually refers to “ZhangSan”, so specific content of the <Tag 1> is <Nickname, 1234560>. <Tag 2> actually refers to “LiSi”, so specific content of the <Tag 2> is <Nickname, 1234567>.

Furthermore, the tag in original tips in embodiments of the present invention starts with “<” and ends with “>”. The tag name and parameter name are case-insensitive. The tag does not support nesting. In order to avoid the problem that the parsing unit 221 can not recognize the tag when original tips contains symbols “<” and “>”, it is possible to define an escape character, for instance, “%” may be defined as an escape character. That is to say, if the body of the original tips contains “<”, “>” or “%”, the symbols “<”, “>” or “%” in the body of the original tips are expressed as “%<”, “%>” or “%%” in original tips transmitted by the first server.

The searching unit 222 is configured to search the data storing module 24 or the second server for terminal information to which the tag refers according to a tag name and a tag parameter of the tag.

More specifically, the <Tag 1> in the embodiment is taken as an example, the searching unit 222 may determine a type of terminal information to which the <Tag 1> refers first according to the tag name “Nickname”, and then determine that specific terminal information to which the <Tag 1> refers is “ZhangSan” according to the tag parameter “1234560”. Similarly, the searching unit 222 may determine that terminal information to which the <Tag 2> refers is “LiSi” according to the tag name and tag parameter of the <Tag 2>.

Above tag format and corresponding searching manner of the searching unit 222 may be used in the situation that the amount of terminal data is large and storage formats of various types of terminal data are inconsistent, and has wide adaptability and better portability.

Preferably, the terminal in the present embodiment includes: a mobile terminal, a client, a personal computer (PC) terminal. Each type of terminal is limited by its own hardware, so that it does not store complete terminal information, or even does not include the data storing module 24. When the terminal stores no terminal information or fails to search out corresponding terminal information from terminal information stored in the terminal, the searching unit 222 may obtain corresponding terminal information from the second server.

The combining unit 223 is configured to replace the tag in the original tips with the terminal information searched out by the searching unit 222, and generate final tips.

More specifically, in the embodiment, the searching unit 222 has determined that <Tag 1> refers to “ZhangSan”, <Tag 2> refers to “LiSi”, then the combining unit 223 replaces <Tag 1> and <Tag 2> in the original tips with determined terminal information, and generates the final tips. That is, the final tips generated by the combining unit 223 are “ZhangSan, LiSi sends you an email, please check and confirm”.

The information displaying module 23 is configured to display the final tips generated by the parsing and combining module 22.

It should be noted that, in the present embodiment, the terminal may be a terminal in the IM system.

The foregoing description is only preferred embodiments of the present invention and is not used for limiting the protection scope thereof. Any modification, equivalent substitution, or improvement made without departing from the spirit and principle of the present invention should be covered by the protection scope of the present invention.

According to the above description of examples, it can be clearly understood by those skilled in the art that the present invention can be realized by software accompanying with necessary general hardware platforms, or by hardware. Based on this, the essential part of the technical solution of the present invention or the part contributed to the prior art can be in the form of a software product, and the computer software product is stored in a storage medium, such as ROM/RAM, diskette, optical disc, and the like, and includes several codes to make a computer device (such as a handset, a personal computer, a server or a network device) perform the method in embodiments of the present invention.

1. A information combining method, comprising:
receiving, by a terminal, original tips, and the original tips comprise a tag;
parsing, by the terminal, the tag, replacing the tag in the original tips with corresponding terminal information, and generating final tips;
displaying, by the terminal, the final tips.

2. The method according to claim 1, wherein receiving, by the terminal, original tips, and the original tips comprise a tag comprises:
receiving, by the terminal, the original tips transmitted by a first server, a portion corresponding to terminal information in the original tips is referred by a tag;
one tag refers to terminal information of one terminal; the terminal information comprises various information related to a user of the terminal, a contact and a buddy of the user.

3. The method according to claim 2, wherein the tag comprises a tag name and a tag parameter, the tag name and the tag parameter jointly determine terminal information to which the tag refers;
the tag name indicates a type of the terminal information to which the tag refers; the tag parameter indicates specific terminal information of the type.

4. The method according to claim 3, wherein parsing, by the terminal, the tag, replacing the tag in the original tips with corresponding terminal information, and generating final tips comprises:
parsing, by the terminal, the tag;
searching, by the terminal, terminal information stored in the terminal itself or that stored in a second server for terminal information to which the tag refers according to the tag name and the tag parameter of the tag;
replacing, by the terminal, the tag in the original with the terminal information to which the tag refers, and generating final tips.

5. The method according to claim 1, wherein the terminal is a terminal in an Instant Messaging system; the first server is a server in the Instant Messaging system.

6. A terminal, comprising: an information receiving module, a parsing and combining module and an information displaying module; wherein
the information receiving module is to receive original tips, and the original tips includes a tag;
the parsing and combining module is to parse the tag, replace the tag in the original tips with corresponding terminal information, and generate final tips;
the information displaying module is to display the final tips generated by the parsing and combining module.

7. The terminal according to claim 6, further comprising:
a data storing module, which is to store terminal information, and provide an access interface for other modules of the terminal; the terminal information comprises various information related to a user of the terminal, a contact and a buddy of the user.

8. The terminal according to claim 7, wherein the tag refers to a portion corresponding to terminal information in the original tips.

9. The terminal according to claim 8, wherein the tag comprises a tag name and a tag parameter; the tag name and the tag parameter jointly determine terminal information to which the tag refers;
the tag name indicates a type of terminal information to which the tag refers;
the tag parameter indicates specific terminal information of the type.

10. The terminal according to claim 9, wherein the parsing and combining module comprises:
a parsing unit, to parse the tag;
a searching unit, to search the data storing module or a second server for terminal information to which the tag refers;
a combining unit, to replace the tag in the original tips with the terminal information searched out by the searching unit, and generate the final tips.

11. An Instant Messaging system, comprising: a first server and a terminal;
the first server is to transmit original tips to the terminal, a portion corresponding to terminal information in the original tips is referred by a tag;
the terminal is to receive the original tips, and parse the tag, replace the tag in the original tips with corresponding terminal information, generate final tips, and display the final tips.

12. The system according to claim 11, further comprising:
a second server, to store terminal information, and provide an access interface for the terminal;
the terminal parses the tag, obtains corresponding terminal information from terminal information stored in the terminal, or from the second server, and replaces the tag in the original tips with obtained terminal information.
